(19) United States
(12) Patent Application Publication
(10) Pub. No.: US 2015/0103450 A1
(43) Pub. Date: Apr. 16, 2015

(54) Thermal Protection For Electrical Device

(71) Applicant: Unico, Inc., Franksville, WI (US)

(72) Inventors: Christoffer S. Fox, Racine, WI (US); Adam E. Anders, Muskego, WI (US); David R. Seidl, Racine, WI (US); Robert T. Burman, Franksville, WI (US)

(21) Appl. No.: 14/503,630

(22) Filed: Oct. 1, 2014

Related U.S. Application Data
(60) Provisional application No. 61/890,378, filed on Oct. 14, 2013.

(51) Int. Cl. H02K 11/00

(52) U.S. Cl. CPC H02K 11/0047; H02K 11/0073
USPC 361/27

(57) ABSTRACT

There is disclosed an apparatus and method for protecting an electrical device. The electrical device is coupled to a power source, and an electric load, a sensor, and a controller. The controller is configured to shut off the electrical device if certain sensed thermal values exceed predetermined values.

### CROSS-REFERENCE TO RELATED PATENT APPLICATIONS

This patent application is a non-provisional application which claims the benefit to U.S. Provisional Patent Application No. 61/890,378, filed Oct. 14, 2013, entitled “Thermal Protection for Electrical Device” and which patent application is hereby incorporated herein by this reference in its entirety.

### FIELD OF THE INVENTION

The present invention relates to converter/inverter devices coupled to electric motors and more particularly to the thermal protection of power semiconductors in the converter/inverter device.

### BACKGROUND OF THE INVENTION

In a motor drive application having a converter/inverter coupled to an electric motor, power semiconductors, for example an insulated-gate bipolar transistor (IGBT), are used in the industrial inverters and converters, and require cooling to avoid failure due to over temperature. If the cooling medium, like gas or liquid, is not present due to problems in the cooling system, or if the ambient temperature is too high the power device can fail due to over temperature. The motor drive is coupled to a power source, typically three-phase and is controlled by a controller, such as, for example, a microprocessor or computer.

The subject matter discussed in this background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

The apparatus of the present disclosure must also be of construction which is both durable and long lasting, and it should also require little or no maintenance to be provided by the user throughout its operating lifetime. In order to enhance the market appeal of the apparatus of the present disclosure, it should also be of inexpensive construction to thereby afford it the broadest possible market. Finally, it is also an objective that all of the aforesaid advantages and objectives be achieved without incurring any substantial relative disadvantage.

### SUMMARY OF THE INVENTION

There is provided an apparatus and method for protecting an electrical device. The electrical device is coupled to a power source, and an electric load.

The apparatus includes a sensor and a controller. The sensor is coupled to the electrical device, with the sensor configured to detect one of a rise in temperature value of the electrical device during the pre-determined time period and a temperature value of the electrical device.

The controller is coupled to the electrical device and the sensor. The controller is configured to shut off the electrical device if the temperature of the electrical device exceeds a pre-determined temperature stored in a database coupled to the controller.

The controller is also configured to determine an estimate of a sensor-to-electrical device temperature rise value based on dissipated power from the electrical device and add such value to the temperature value of the electrical device. The controller is also configured to determine an ambient-to-sensor temperature rise value to obtain an estimate ambient temperature value based on dissipated power from the electrical device. The controller also determines a rate of change of ambient temperature value.

The controller compares the estimated temperature value of the electrical device to the pre-determined temperature value and if the estimated temperature values exceed the pre-determined temperature value, the controller will shut off the electrical device.

In another embodiment, the apparatus and method provides the controller configured to compare the rate of change of ambient temperature value to a first rate of change of ambient temperature value stored in the database and a second rate of change of ambient temperature value stored in the database, if the rate of change of the ambient temperature value exceeds the first rate of change of ambient temperature for any period of time, the controller will shut off the electrical device, if the rate of change of ambient temperature values exceeds the second rate of change of ambient temperature value for a period of time longer than a pre-determined period of time stored in the database, the controller will shut off the electrical device.

In another embodiment of the apparatus and method, the sensor is a thermistor which can be a negative temperature coefficient-type thermistor.

In another embodiment, the apparatus and method provides an insulated-gate bipolar transistor-type electrical device. More than one electrical device can be utilized in the apparatus with the additional electrical device being an insulated-gate bipolar transistor.

The apparatus of the present invention is of a construction which is both durable and long lasting, and which will require little or no maintenance to be provided by the user throughout its operating lifetime. Finally, all of the aforesaid advantages and objectives are achieved without incurring any substantial relative disadvantage.

### DESCRIPTION OF THE DRAWINGS

These and other advantages of the present disclosure are best understood with reference to the drawings, in which:

FIG. 1 is a schematic diagram of a motor drive system including a controller configured to protect an electric device from failure due to a thermal overload.

FIG. 2 is a schematic of the converter/inverter illustrated in FIG. 1, with the inverter portion including a plurality of insulated-gate bipolar transistor (IGBT) type electrical devices in a motor device, with at least one thermistor type sensor associated with at least one of the electric devices.

FIG. 3 is a schematic illustration of the relationship between the temperatures of the IGBT, the ambient and the sensor in the apparatus illustrated in FIG. 2.

FIG. 4 is a flow chart diagram of a configuration in the controller illustrated in FIG. 1 to prevent failure of the electrical device illustrated in FIG. 2 due to a thermal overload based on the relationship illustrated in FIG. 3.

FIG. 5 is a schematic diagram of the method and functions illustrated in FIG. 4.

### DETAILED DESCRIPTION OF THE EXEMPLARY EMBODIMENTS

Power semiconductors, for example an insulated-gate bipolar transistor (IGBT), are used in industrial inverters and converters, and require cooling to avoid failure due to over temperature. If the cooling medium, like gas or liquid, is not present due to problems in the cooling system, or if the ambient temperature is too high the power device can fail due to over temperature. This disclosure is used to detect when the cooling medium is not present or if the ambient temperature is too high so the inverter or converter can shut down before failure of the power semiconductor.

Newer IGBTs are equipped with a negative temperature coefficient thermistor (ntc). The ntc temperature can be used to estimate the junction temperature, and the ambient temperature. If either of these temperatures exceeds a maximum value, or if the ambient increases too quickly, the inverter will fault, shut off, or be damaged. If the device does not provide a temperature feedback, another sensor in close proximity to the device can be used, but this may not be as good.

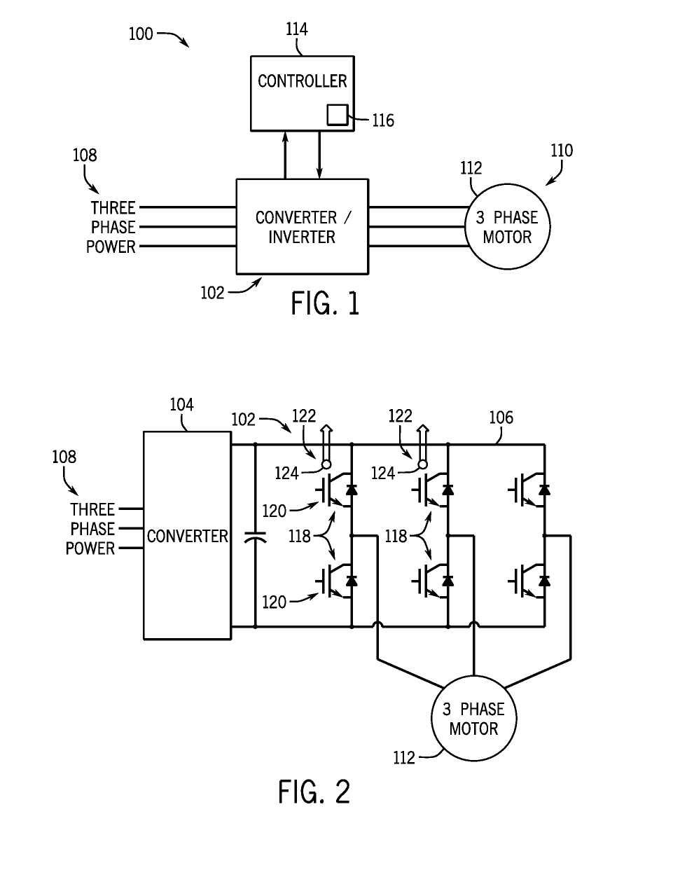

The thermal protection described protects the inverter section of a motor drive application like the one shown in FIG. 1. The system 100 includes a power electronic converter and inverter section 102 that is controlled by a controller 114 to convert its three phase power input to a dc link that is converted to control electrical load 110, for example an electric motor 112. Appropriate instrumentation is coupled to the motor drive to monitor the current and voltage of the various components and used by the controller.

A typical inverter section 106 that includes six electrical devices 118, for example an insulated-gate bipolar transistor (IGBT) 120 that are used to convert the dc link to control a motor 112. An IGBT specifies a maximum allowable junction temperature at which it can operate. When the power device is used to convert power, it dissipates power 130 and produces a temperature rise. If this temperature rise results in an absolute junction temperature 144 that exceeds the maximum allowable temperature, the IGBT will fail.

The protection apparatus 100 disclosed will use a temperature sensor 122, for example a thermistor 124. While the IGBT is operating, there is a temperature rise 128 from the ambient temperature 146 to the temperature sensor 122, and a temperature rise 126 from the temperature sensor 122 to the junction of the IGBT 120. The junction temperature can be calculated by adding three temperatures together; the ambient temperature 146, the ambient to temperature sensor rise 128, and the temperature sensor to junction temperature rise 126.

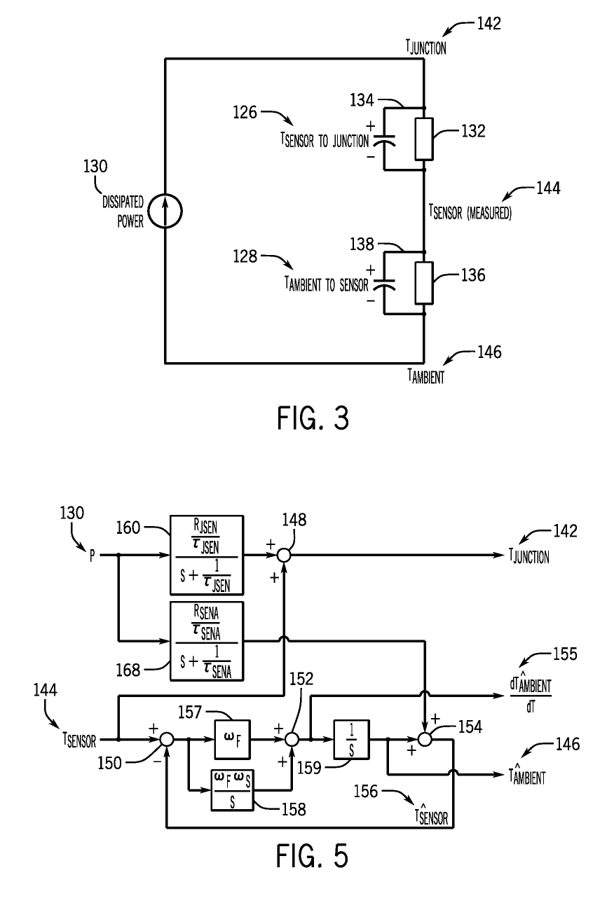

The relationship between the sensor temperature 144, the junction temperature 142, and ambient temperature 146 is illustrated in FIG. 3. The relationship is dependent on the power dissipated 130 in the device 120 and the impedance to the flow of the power 130 to ambient 146. The temperature rise that occurs due to the dissipated power 130 is described by two parts, the temperature rise 126 from the sensor 122 to the junction 120, 126, and the temperature rise 128 from ambient temperature 146 to the sensor 122. Each of these temperature rises 126, 128 has a steady state component that determines the final temperature if the power is constant. This is the thermal resistance and is modeled by resistors 132 and 136. There is also a component that determines how the temperature responds dynamically to changes in the dissipated power 130 and is modeled by capacitors 134 and 138. The resistor and capacitor cause the response of the temperature rise from sensor to junction 126 and the temperature rise from ambient temperature to sensor 128 to changes in the dissipated power 130 to be a first order response. It is well understood that a first order response is described in the frequency domain by:

$$\frac{T ( s )}{P ( s )} = \frac{\frac{R}{τ}}{s + \frac{1}{τ}}$$

Where T(s) is the temperature rise (either 126 or 128) P(s) is the dissipated power 130 R is the thermal resistance (either 132 or 136), and τ is the thermal time constant resulting from the resistor and capacitor combination either (132 and 134) or (136 and 138).

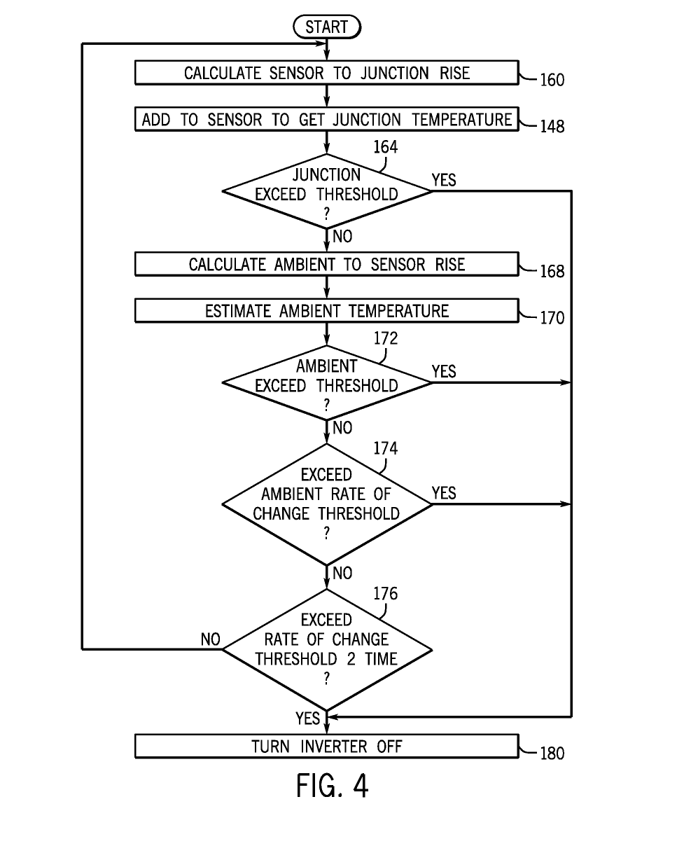

The proposed apparatus and method employs four methods of detecting loss of coolant, either liquid or gas, or unacceptable ambient temperature 146 in the apparatus 100. FIG. 4 is a flow chart explaining the method used to detect loss of coolant or unacceptable ambient temperature.

The first method used to detect loss of coolant or unacceptable ambient temperature 146 is to calculate a junction temperature 142 and compare it to a maximum allowable junction temperature that is stored in a controller 114. Typically, the maximum allowable temperature of the IGBT 120 is set by the manufacturer or by the user of the apparatus 100. To do this, a sensor to junction temperature rise 126 is calculated at 160 in the flow chart of FIG. 4, and added to the measured sensor temperature 144 at 148 in the flow chart of FIG. 4 to determine the junction temperature 142. This is also shown in FIG. 5, block 160, where the first order response described earlier is used to calculate a temperature rise from the temperature sensor to the junction 126 based on the dissipated power 130. FIG. 4, decision point 164 is the point at which the calculated junction temperature 142 is compared to the maximum allowable junction temperature stored in the database 116, and if the calculated junction temperature 142 exceeds the maximum allowable junction temperature the inverter 106 will shut off 180.

The second method used for thermal protection is described in the flow chart in FIG. 4, steps 168 and 170. An ambient temperature to sensor temperature rise 128 is calculated, and is used to estimate the ambient temperature 146. FIG. 5, in block 168 shows this where the first order response previously described is used to calculate a temperature rise from ambient temperature to the temperature sensor 128 based on the dissipated power 130. Decision point 172 in FIG. 4 compares the estimated ambient temperature 146 to the maximum ambient temperature allowed that is stored in the controller 114, and if the estimated ambient temperature 146 exceeds this maximum ambient temperature, the inverter 106 will shut off 180.

FIG. 5 describes how the ambient estimate 146 is determined. The controller 114 is configured, as illustrated by the block diagram in FIG. 5 to cause the difference between the measured sensor temperature 144 and an estimate of the sensor temperature 156 to be zero. This is done by employing a proportional integral controller. The error, or difference, between the measured temperature sensor 146 and the estimate of the sensor temperature 156, is determined at node 150 in FIG. 5. This error is multiplied by a proportional term at 157 and integrated and multiplied by an integral term at 158. The result of 157 and 158 are added together at node 152, and this sum is integrated 159. The result of the integration at 159 is added to the ambient to sensor rise 128 at node 154, and fed back to node 150 as the estimate of the sensor temperature 156. For the estimate of the sensor temperature 156 to be equal to the measured sensor temperature 144, the result of the integrator block 159 that is added to the ambient to sensor rise 128 is the estimate of the ambient temperature 146. For the output of the integrator block 159 to be equal to the estimate of the ambient temperature 146, the input to the integrator block 159 must be the derivative of the ambient temperature or the rate of change of the ambient temperature 155.

The third and fourth methods for thermal protection of IGBT 120 in the inverter 106 use the rate of change of the ambient temperature 155. The ambient temperature 146 should not change at a high rate of change. If the measured sensor temperature 144 increases quickly, and is not explained by an increase of the ambient temperature to sensor temperature 128, the reason for the increase of the measured sensor temperature 144 is because the ambient temperature 146 is increasing quickly or because the cooling system, liquid gas, is not performing well enough to prevent the increase in temperature.

FIG. 4 describes, at decision point 174, the third method of thermal protection of the inverter 106 that compares the rate of change of the ambient temperature to a maximum allowed rate of change of the ambient temperature that is stored in the database 116 of the controller 114, and if the rate of change of the ambient temperature 155 exceeds a first rete of change of ambient temperature, for example a maximum allowed rate of change, the inverter 106 will shut off 180.

Decision point 176, also illustrated in FIG. 4 is the fourth method of thermal protection of the IGBT 120 in the inverter 106 by comparing the amount of time that the ambient temperature rate of change exceeds a second ambient temperature rate of change value, also stored in the database 116 coupled to the controller 114, to the maximum time that the ambient temperature rate of change is allowed to exceed the second ambient temperature rate of change value. The maximum time that the ambient temperature rate of change is allowed to exceed this second ambient temperature rate of change value is also stored in the database 116 of the controller 114. If the ambient temperature rate of change exceeds the second ambient temperature rate of change value for longer than the maximum time allowed the inverter 106 will shut off 180.

An example of how methods three and four work is described below:

If the ambient temperature rate of change value used by method three was defined in the controller as 1 per unit, and the actual ambient temperature rate of change was greater than 1 per unit, decision point 174 in FIG. 4 would cause the controller 114 to turn the inverter off 180.

If the ambient temperature rate of change value 2 was defined in the controller as 0.5 per unit, and the actual ambient temperature rate of change was greater than 0.5 per unit but less than 1 per unit, decision point 174 in FIG. 4 would not turn the inverter off.

If the maximum time that the ambient temperature rate of change was allowed to exceed the ambient temperature rate of change value 2 defined in this example as 0.5 per unit was defined as 2 seconds, and the amount of time that the ambient temperature rate of change has exceeded 0.5 per unit is less than 2 seconds, decision point 176 in FIG. 4 will not turn the inverter off.

If however, the ambient temperature rate of change has exceeded the 0.5 per unit value longer than the maximum allowed 2 seconds, decision point 176 will cause the controller 114 to turn the inverter 106 off 180.

The controller 114 may be a microprocessor coupled to the various apparatus of the system. The controller 114 may also be a server coupled to an array of peripherals or a desktop computer, or a laptop computer, or a smart-phone. It is also contemplated that the controller is configured to control each individual machine and may be remote from any of the apparatus. Communication between the controller 114 and the various apparatus may be either by hardwire or wireless devices. A memory/data base 116 coupled to the controller may be remote from the controller 114. The controller 114 typically includes an input device, for example a mouse, or a keyboard, and a display device, for example a monitor screen or a smart phone. Such devices can be hardwired to the controller 114 or connected wirelessly with appropriate software, firmware, and hardware. The display device may also include a printer coupled to the controller 114. The display device may be configured to mail or fax reports as determined by a user. The controller 114 may be coupled to a network, for example, a local area network or a wide area network, which can be one of a hardwire network and a wireless network, for example a Bluetooth network or internet network, for example, by a WIFI connection or “cloud” connection.

For purposes of this disclosure, the term “coupled” means the joining of two components (electrical or mechanical) directly or indirectly to one another. Such joining may be stationary in nature or moveable in nature. Such joining may be achieved with the two components (electrical or mechanical) and any additional intermediate members being integrally formed as a single unitary body with one another or the two components and any additional member being attached to one another. Such adjoining may be permanent in nature or alternatively be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be claimed alone or in combination with any of the features, elements, or components of any of the other embodiments discussed above.

Although the foregoing description of the present mechanism has been shown and described with reference to particular embodiments and applications thereof, it has been presented for purposes of illustration and description and is not intended to be exhaustive or to limit the disclosure to the particular embodiments and applications disclosed. It will be apparent to those having ordinary skill in the art that a number of changes, modifications, variations, or alterations to the mechanism as described herein may be made, none of which depart from the spirit or scope of the present disclosure. The particular embodiments and applications were chosen and described to provide the best illustration of the principles of the mechanism and its practical application to thereby enable one of ordinary skill in the art to utilize the disclosure in various embodiments and with various modifications as are suited to the particular use contemplated. All such changes, modifications, variations, and alterations should therefore be seen as being within the scope of the present disclosure as determined by the appended claims when interpreted in accordance with the breadth to which they are fairly, legally, and equitably entitled.

What is claimed is:

1. An apparatus for protecting an electrical device, the electrical device coupled to a power source and an electric load, the apparatus comprising:
a sensor coupled to the electrical device, with the sensor configured to detect one of a rise in temperature value of the electrical device during a predetermined time period and a temperature value of the electrical device; and
a controller coupled to the electrical device and the sensor, with the controller configured to shut off the electrical device if a temperature of the electrical device exceeds a predetermined temperature stored in a database coupled to the controller, the controller is further configured to:
a: determine an estimate of a sensor to electrical device temperature rise value based on dissipated power from the electrical device and add such value to the temperature value of the electrical device,
b: determine an ambient temperature to sensor temperature rise value to obtain an estimate ambient temperature value based on dissipated power from the electrical device,
c: determine a rate of change of ambient temperature value,
d: compare the estimated temperature value of the electrical device to the predetermined temperature value, and
if the estimated temperature values exceed the predetermined temperature value, the controller will shut off the electrical device.

2. The apparatus of claim 1, further comprising the controller configured to compare the rate of change of ambient temperature value to a first rate of change of ambient temperature value stored in the database and a second rate of change of ambient temperature value stored in the database,
if the rate of change of the ambient temperature value exceeds the first rate of change of ambient temperature for any period of time, the controller will shut off the electrical device,
if the rate of change of ambient temperature value exceeds the second rate of change of ambient temperature value for a period of time longer than a pre-determined period of time stored in the database, the controller will shut off the electrical device.

3. The apparatus of claim 1, wherein the sensor is a thermistor.

4. The apparatus of claim 3, wherein the thermistor is a negative temperature coefficient type.

5. The apparatus of claim 1, wherein the electrical device is an insulated-gate bipolar transistor.

6. The apparatus of claim 5, wherein the electrical device includes at least one additional insulated-gate bipolar transistor.

7. The apparatus of claim 5, wherein the insulated-gate bipolar transistor is coupled to a converter.

8. The apparatus of claim 1, wherein the electric load is an electric motor.

9. A method for protecting an electrical device, the electrical device coupled to a power source, and an electric load, the method comprising:
coupling a sensor to the electrical device, with the sensor configured to detect one of a rise in temperature value of the electrical device during a predetermined time period and a temperature value of the electrical device;
coupling a controller to the electrical device and the sensor, with the controller configured to shut off the electrical device if a temperature of the electrical device exceeds a predetermined temperature stored in a database coupled to the controller; and configuring the controller to:
a: determine an estimate of a sensor to electrical device temperature rise value based on dissipated power from the electrical device and add such value to the temperature value of the electrical device,
b: determine an ambient temperature to sensor temperature rise value to obtain an estimate ambient temperature value based on dissipated power from the electrical device,
c: determine a rate of change of ambient temperature value,
d: compare the estimated temperature value of the electrical device to the predetermined temperature value, and
if the estimated temperature values exceed the predetermined temperature value, shutting off the electrical device.

10. The method of claim 9, further comprising configuring the controller to compare the rate of change of ambient temperature value to a first rate of change of ambient temperature value stored in the database and a second rate of change of ambient temperature value stored in the database,
if the rate of change of the ambient temperature value exceeds the first rate of change of ambient temperature for any period of time, the controller shuts off the electrical device,
if the rate of change of ambient temperature value exceeds the second rate of change of ambient temperature value for a period of time longer than a pre-determined period of time stored in the database, the controller will shut off the electrical device.

11. The method of claim 9, wherein the sensor is a thermistor.

12. The method of claim 11, wherein the thermistor is a negative temperature coefficient type.

13. The method of claim 9, wherein the electrical device is an insulated-gate bipolar transistor.

14. The method of claim 13, wherein the electrical device includes at least one additional insulated-gate bipolar transistor.

15. The method of claim 13, wherein the insulated-gate bipolar transistor is coupled to a converter.

16. The method of claim 9, wherein the electric load is an electric motor.
